(19) United States
(12) Patent Application Publication
(10) Pub. No.: US 2011/0023755 A1
(43) Pub. Date: Feb. 3, 2011

(54) GRANULAR COMPOSITION COMPRISING AN ANHYDRITE III HYDRAULIC BINDER AND AN ALUMINA-BASED GRANULAR MATERIAL

(76) Inventor: Edouard Dumoulin, Nice (FR)

Correspondence Address: JEROME D. JACKSON (JACKSON PATENT LAW OFFICE), 211 N. UNION STREET, SUITE 100, ALEXANDRIA, VA, 22314, US

(21) Appl. No.: 11/993,875

(22) PCT Filed: Jun. 27, 2005
(86) PCT No.: PCT/FR05/01616

§ 371 Date: Jan. 14, 2010

(51) Int. Cl. C04B 28/06

(52) U.S. Cl. 106/694; 106/695

(57) ABSTRACT

The invention concerns a granular composition designed to be reacted with water to form a refractory material, characterized in that it comprises an anhydrite III hydraulic binder and an alumina-based granular material. The invention aims at making a cold-processed refractory material which does not necessarily have to be cured prior to use, said material having very good refractory and mechanical properties for high (>1000° C.) and very high (>1600° C.) temperatures.

An object of the present invention is a granulous composition including an anhydrite III hydraulic binder and an alumina-based aggregate.

An object of the present invention is also the use of this granular composition for the manufacture of a refractory material.

Another object of the present invention is different manufacturing processes of this granular composition.

The invention relates to the general technical field of cements and in particular dry granular compositions composed of a hydraulic binder and of an aggregate, and designed to react with water to form a concrete type material.

It relates more particularly to the technical field of such granular compositions useful for the manufacture of refractory materials processed cold and not cured before use.

Refractory materials are materials able to resist high temperatures (>1000° C.) while keeping a dimensional and functional stability.

The principal qualities of a refractory material are its resistance to repeated thermal shocks (chemical, structural, and dimensional stability), its capacity of thermal isolation or conduction, its resistance to corrosion (chemical deterioration of the structure due to attack mechanisms by contact with liquids, gases or solid particles), its resistance to the abrasion (wear of surface by friction, rolling or impact) and its resistance to crumbling (due to fatigue and to thermal shocks).

It is known to employ cold-processed refractory materials starting from a granular composition (hydraulic binder+aggregate) that one mixes with the water to form a pasty mixture capable of drying and of hardening.

Known in particular are cold-processed refractory materials possessing good refractory properties without it being necessary to cure them before use.

This is notably the case for the aluminous cements rich in alumina Al₂O₃.

The basic granular composition is made starting from bauxite and limestone from which one extracts the alumina by alkaline attack to form a soda aluminate, from which one subsequently precipitates the aluminum hydrate, which then produces the alumina by calcination at approximately 1300-1350° C.

Known also are sulphate-aluminous refractory cements comprising a substantial proportion of calcium sulphate-aluminate (CaO)₄(Al₂O₃)₃SO₄. The manufacture of the granular composition is performed by curing, at 1250° C.-1300° C., of a mixture of limestone, alumina (bauxite), and calcium sulphate (gypsum).

The manufacture of these granular compositions is, however, complex and necessitates a large consumption of energy, the temperature and the curing time being relatively elevated.

Moreover, bauxite being a rare and expensive mineral, industrial use such of cements is not very profitable.

A purpose of the present invention is to remedy this state of affairs, in particular because it offers a granular composition designed to react with water to form a refractory material, the aforementioned composition being inexpensive, easy to make and allowing to vary in a simple manner the refractory and mechanical properties of the material according to the use which is made of it.

Another goal of the invention is to use this granular composition for manufacture of a cold-processed refractory material that is not necessarily cured before use, the aforementioned material possessing very good refractory and mechanical properties for the high (>1000° C.) and very high temperatures (>1600° C.).

Another goal of the invention is to offer different manufacturing processes of the granular composition easy to implement and consuming a quantity of energy approximately four times less substantial than those of the processes of the prior art.

The applicant has now surprisingly demonstrated that an anhydrite III and alumina refractory material was possessing totally remarkable refractory and mechanical properties.

It has been proposed in patent FR2839969 (Couturier) to manufacture a hydraulic binder of the cement type enabling attainment of mortars or concretes having elevated-mechanical resistance properties under normal use conditions, with the possibility of modulating the setting time. The process comprises mixing a first hydraulic binder having a pozzolanic character including alumina, and a second anhydrite III hydraulic binder. However, this document does not teach mixing an anhydrite hydraulic binder with an alumina aggregate to manufacture materials possessing very good refractory and mechanical properties for the high (>1000° C.) and the very high temperatures (>1600° C.).

The previously cited goals are thus reached with the aid of a granular composition designed to react with water to form a refractory material, characterized by the fact that it includes an anhydrite III hydraulic binder and an alumina aggregate.

According to a preferred feature of the invention, the hydraulic binder furthermore comprises anhydrite II, the presence of this compound acting in synergy with the anhydrite III to optimize the refractory and mechanical properties of the material. Optimally, the hydraulic binder comprises a proportion of anhydrite III greater than the proportion of anhydrite II.

According to an advantageous feature of the invention, the granular composition includes between 25% and 50% p/p_{composition}, preferably 30%, of anhydrite III hydraulic binder and between 50% and 75% p/p_{composition}, preferably 70%, of alumina aggregate. The proportion of hydraulic binder being minority, one can easily vary the refractory and mechanical properties of the material while varying the density and alumina content of the aggregates employed.

According to another feature of the invention, the anhydrite III hydraulic binder and the alumina aggregate are doped to react approximately 3 to approximately 5 moles of anhydrite III with approximately 2 to approximately 4 moles of alumina and preferably to react approximately 4 moles of anhydrite III with approximately 3 moles of alumina.

According to another advantageous feature of the invention, the alumina aggregate is selected from the list of the following aggregates taken alone or in combination: calcinated bauxite, tabular alumina, calcinated alumina, calcinated refractory clay, refractory chamotte, pearlite, vermiculite, bentonite, magnesite, dolomite, slag, white or brown corundums, kerphalite, alumina hydrate, recycled asbestos, molten aluminous cement.

When the refractory material in accordance with the invention is subjected to very high temperatures (≧1600° C.), one will optimally use spinel of alumina magnesia.

According to another feature of the invention, one uses an anhydrite III hydraulic binder stabilized in a manner to preserve the properties of the granular composition during long term storage, the anhydrite III being a metastable hygroscopic phase that rehydrates quickly in conventional calcium sulphate β in ambient air.

The goals of the invention cited previously are also achieved by the fact that one uses the granular composition object of the invention, for the manufacture of a refractory material having, at approximately 1100° C., a calcium sulphate-aluminate exterior skin acting as a reflecting heat shield and allowing the refractory material to resist very high temperatures without substantial deterioration of its qualities.

The particular reaction appearing at approximately 1100° C. must be understood according to the invention as occurring at atmospheric pressure.

According to an advantageous feature of the invention, one manufactures the refractory material cold, without curing before use. But a curing before use can be considered according to the stresses to which the material will be subjected.

According to another preferred feature of the invention, one makes the refractory material by mixing the granular composition with the water to form a pasty mixture, by implementing the aforementioned pasty mixture according to the desired application, then by leaving to dry the aforementioned mixture until it hardens to form the aforementioned refractory material. The manufacturing process is thus very simple and economical in energy, labor, and process.

In order to vary the refractory and/or mechanical properties of the material in accordance with the invention, the proportion of water mixed with the granular composition optimally ranges between 40% and 80% p/p_{binder}.

The goals cited previously are also achieved by a manufacturing process of the granular composition in accordance with the invention, comprising dry mixing an anhydrite III hydraulic binder stabilized with an alumina aggregate.

According to a feature of manufacture, one dry mixes a stabilized anhydrite III and anhydrite II hydraulic binder with an alumina aggregate and, preferably, the proportion of anhydrite III is greater than the proportion of anhydrite II.

In an implementation alternative, the manufacturing process comprises heating of the calcium sulphate to a dehydration temperature ranging between 220° C. and 360° C. according to the nature of the calcium sulphate treated to form anhydrite III, and subsequently mixing at the dehydration temperature the anhydrite III with the alumina aggregate. The dehydration temperature of the calcium sulphate being relatively low, such an industrial process is quite profitable and, moreover, easy to implement.

In another implementation alternative, the manufacturing process comprises heating of the calcium sulphate to a dehydration temperature ranging between 220° C. and 360° C. according to the nature of the calcium sulphate treated to form anhydrite III, and subsequently mixing in a dry atmosphere the anhydrite III with the alumina aggregate.

By “dry atmosphere”, one means an atmosphere having a moisture content less than 5% by weight, preferably less than 1%.

In another implementation alternative, the manufacturing process comprises heating of the calcium sulphate to a dehydration temperature greater than 360° C. according to the nature of the calcium sulphate treated to form anhydrite II and anhydrite III, and subsequently mixing the anhydrite III and the anhydrite II with the alumina aggregate.

Other features and advantages of the present invention will better reemerge at the reading of description and the examples that will follow, made by way of guiding, non-limiting examples, with regard to the attached drawing on which:

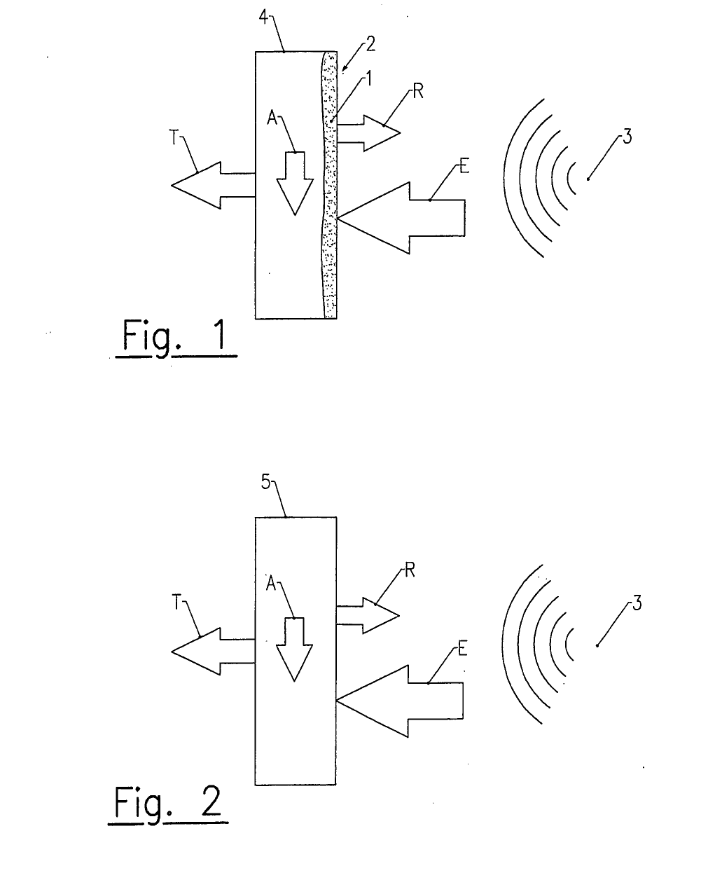

FIG. 1 is a schematic view of a refractory brick implemented according to the invention, showing the zones of formation of calcium sulphate-aluminate when the aforementioned brick is exposed to temperatures greater than 1100° C. and showing the existing thermal exchanges;

FIG. 2 is a schematic view of a conventional calcium sulphate-aluminate refractory brick, showing the existing thermal exchanges.

The hydraulic binder is used mainly to ensure the cohesion of the alumina aggregates between themselves in order to give an optimal mechanical resistance to the refractory material in accordance with the invention.

Anhydrite III hydraulic binders are well known to the person of skill in the art. A dehydration intensity (from 220° C. to 360° C.) of calcium sulphate, natural (gypsum), or synthetic (sulfogypse, phosphogypsum, borogypse, titanogypes, etc), having formula (CaSO₄, 2H₂O) results in the formation of the anhydrite III having formula (CaSO₄, εH₂O) with £ from 0.1 to 0.2. An even more intense dehydration (>360° C.) results in the formation of the anhydrite II having formula (CaSO₄, 0H₂O).

The anhydrite III being strongly hygroscopic, it rehydrates quickly in hemi-hydrate or conventional calcium sulphate β having formula (CaSO₄, ½H₂O) then returns to the calcium sulphate state according to the hygrometry of the air.

The person of skill in the art knows in particular via patents FR2733496 (Dussel), FR2767815 (Couturier) and FR2767816 (Couturier), of the process of preparation of stabilized anhydrite III that include the following two steps:

a) curing of the gypsum to form the anhydrite III;

b) thermal quenching making it possible to stabilize the metastable phase of the anhydrite III.

A stabilized anhydrite III hydraulic binder makes it possible to obtain materials having an elevated mechanical resistance and thermal and acoustic isolation properties greater than those of conventional calcium sulphate or cement.

One never obtains 100% stabilized anhydrite III (this always being in association with the semi-hydrate (CaSO₄, ½H₂O) and impurities coming from the calcium sulphate starting material. The percentage of stabilized anhydrite III is a function of the process used (temperatures, curing and quenching time, size grading of the calcium sulphate are determinants).

According to a preferred mode of manufacture:

a) one heats natural or synthetic calcium sulphate to a dehydration temperature ranging between 220° C. and 360° C. according to the nature of the calcium sulphate treated to form anhydrite III;

b) one subjects the material thus transformed to a thermal quenching in order to lower its temperature from at least 150° C. to reach a temperature at least less than 110° C., preferably less than 80° C., preferably still in less than 2 minutes.

This process, as well as the industrial installation allowing the implementation of the aforesaid process, are described in more detail in application FR2804423 and enable obtaining in an industrial process stabilized anhydrite III with a degree of purity of at least 85%, able to reach 95% and more compared to the total weight of the compounds coming from the transformation of the hydrate of calcium sulphate in the starting material.

According to the process described in FR2856679 (Couturier), it is possible to obtain in an industrial process stabilized anhydrite III with a degree of purity at least equal to that obtained by the process of FR2804423 and of better quality, by using as powdery starting material conventional calcium sulphate β or ground β hemi-hydrate, having size grading of less than 200 microns, preferably less than 150 microns, preferably still less than 100 microns, and by carrying out the same successive steps of curing and quenching described in FR2804423, without however requiring a pre-drying step to the extent that the calcium sulphate β common in the industry is already dry.

One preferably uses stabilized anhydrite III hydraulic binders, made according to the specific processes described above and particularly made according to the process described in patent application FR2804423.

The aggregates employed are based on alumina Al₂O₃ (aluminum oxide), preferably without trace of water.

The aggregates employed never contain 100% Al₂O₃ and generally comprise impurities.

Table 1 that follows compiles different alumina-based aggregates that one can employ alone or in combination in the composition object of the invention according to the application of the refractory material.

TABLE 1
different alumina-based aggregates

| | % Al₂O₃ | |
|---|---|---|
| Aggregate | (p/p_{aggregate}) | Application |
| Calcinated bauxite | 90 | any temperature |
| Calcinated refractory clay | 40 | Low temperature |
| Calcinated alumina | 99.5 | High temperature |
| Tabular alumina | 99.5 | High temperature |
| Refractory chamotte | 42 | Low temperature |
| Pearlite | 13 | Low temperature |
| Vermiculite | <50 | Low temperature |
| Bentonite | <50 | Low temperature |
| Magnesite | >50 | High temperature |
| Dolomite | 63 | High temperature |
| Slag | 14 | Low temperature |
| White or brown | Strong content | High temperature |
| corundum | | |
| Kerphalite | 60 | High temperature |
| Alumina magnesia Spinel | 66 | Very high temperature |
| Alumina Hydrate | 65 | High temperature |
| Recycled asbestos | 4 | Low temperature |
| Molten aluminous cement | >50 | High temperature |

The applicant noticed that the larger the proportion of alumina, the more the refractory properties are elevated. The features of the aggregates employed thus depend on the application of the refractory material, depending on whether it is used for high (>1000° C.) or very high temperatures (>1600° C.). One will use preferably spinel of alumina magnesia for very high temperatures greater than or equal to 1600° C.

According to a preferred implementation mode, one uses between 25% and 50% p/p_{composition} of anhydrite III and between 50% and 75% p/p_{composition} of alumina aggregate. And optimally, the anhydrite III hydraulic binder and the alumina aggregate are doped to react approximately 3 to approximately 5 moles of anhydrite III with approximately 2 to approximately 4 moles of alumina and preferably to react approximately 4 moles of anhydrite III with approximately 3 moles of alumina.

The hydraulic binder being in the minority in the object composition of the invention, one can adjust the density of the refractory material while varying the choice of density of the alumina aggregates.

By increasing the density and/or the proportion of the aggregates, one increases in particular the mechanical resistance, the fire rating, and the abrasion and corrosion resistance of the refractory material.

By lowering the density and/or the proportion of the aggregates, one increases in particular the porosity, insulating properties and the resistance to thermal shocks of the refractory material.

To manufacture the granular composition, one optimally uses a stabilized anhydrite III hydraulic binder, for example a hydraulic binder made according to the process described in patent application FR2804423.

One can also employ a stabilized anhydrite III and anhydrite II hydraulic binder, optimally with a proportion of anhydrite III greater than the proportion of anhydrite II.

One dry mixes between 25% and 50% p/p_{composition} of hydraulic binder based on stabilized anhydrite III and possibly anhydrite II and between 50% and 75% p/p_{composition} of alumina aggregate to the point of achieving a homogeneous granular composition. To obtain optimal refractory and mechanical properties, one mixes 30% p/p_{composition} of stabilized anhydrite III hydraulic binder and between 70% p/p_{composition} of alumina aggregate.

The composition thus prepared must be conserved in a rather dry place, without another particular constraint due to the stability of the anhydrite III.

In an implementation alternative, one heats natural calcium sulphate (gypsum) to a dehydration temperature ranging between 220° C. and 360° C. to form anhydrite III.

To avoid the anhydrite III retransforming into hemihydrate and to use its properties immediately, one dry mixes, at the dehydration temperature, the material obtained with the alumina aggregate.

One uses between 25% and 50% p/p_{composition} of gypsum and between 50% and 75% p/p_{composition} of alumina aggregate.

The homogeneous granular composition obtained must be stored in dry atmosphere or be used within 4 hours, optimally within 2 hours, in order to avoid a too substantial rehydration of the anhydrite III.

In another implementation alternative, one heats natural calcium sulphate (gypsum) to a dehydration temperature ranging between 220° C. and 360° C. to form anhydrite III.

One optimally allows the material thus obtained to cool in dry atmosphere and at ambient temperature to avoid the anhydrite III rehydrating spontaneously.

One mixes in dry atmosphere between 25% and 50% p/p_{composition} of the anhydrite III binder with between 50% and 75% p/p_{composition} of alumina aggregate to the point of achieving a homogenous granular composition.

The granular composition obtained must be stored in dry atmosphere or be used within 4 hours, optimally within 2 hours, in order to avoid a too substantial rehydration of the anhydrite III.

In another implementation alternative, one heats calcium sulphate to a dehydration temperature greater than 360° C. according to the nature of the calcium sulphate treated to form anhydrite II and anhydrite III.

One optimally carries out a thermal quenching to stabilize the anhydrite III.

One mixes the anhydrite II and the anhydrite III with the alumina aggregate, in a dry atmosphere and/or at the dehydration temperature or under normal conditions if one has previously carried out thermal hardening, to the point of obtaining a homogeneous granular composition.

The homogeneous granular composition obtained must be stored in dry atmosphere or be used within 4 hours, optimally within 2 hours, in order to avoid a too substantial rehydration of the anhydrite III. In the case where thermal hardening is carried out, the composition thus prepared is conserved in a rather dry place, without another particular constraint.

One uses the granular composition made according to one of the processes in accordance with the invention by mixing it with the water to form a pasty mixture according to the following reaction:

(CaSO₄,εH₂O)+Al₂O₃+(H₂O)ₙ→(CaSO₄,2H₂O)+Al₂O₃+(H₂O)ₙ₋₂(n>2)

The anhydrite III rehydrates into gypsum according to the chemical formula, but with a crystalline structure different from that of natural gypsum, conferring to the obtained hydraulic binder absolutely remarkable mechanical features.

One then leaves the dry pasty mixture until it hardens and forms the refractory material.

The pasty mixture sets in from 10 minutes to 3 hours according to the mixed quantity of water. Setting retarders, optimally citric acid, one of its derivatives, ligno-sulphonate or other retarders well known to the person of skill in the art, can also be employed. Likewise, one can use setting activators, of the alkaline basic agents type, preferably of hydrated lime, fat lime, soda, alkaline silicates, preferably of lithium or soda meta-silicates. The setting activators or retarders are mixed with the granular composition at the time of its manufacture or the time of the preparation of the pasty mixture, in proportions ranging between 4% to 20% p/p_{composition}.

Before its hardening, the pasty mixture can be implemented by projection or gunitage (the pasty mixture possessing excellent adhesion capacities on the support on which one implements it) by casting or molding, vibrational casting, injection, stratification, extension, hydraulic pressing, etc, according to the application of the refractory material.

The proportion of water mixed with the granular composition optimally ranges between 40% and 80% p/p_{binder}. One needs approximately 19% p/p_{binder} of water to rehydrate the anhydrite III. The extra quantity of water, by evaporating, will form hollows and thus make the refractory material more or less porous. By increasing the porosity, one increases the resistance to the thermal shocks and one decreases the thermal conductivity, the air contained in the pores acting to isolate. By lowering the porosity of the refractory material, one increases the mechanical resistance, the resistance to abrasion and to corrosion.

One will preferably use a porous material in applications where the insulating properties are necessary. This is the case in particular in siderurgy where the baths of fused metal must be maintained at temperature without thermal loss (which, moreover, provides comfort for the workmen working in proximity to the aforesaid tanks and promotes energy savings). The tanks containing such baths will be thus preferably constituted by a refractory material made from the granular composition object of the invention mixed with approximately 50% to 60% p/p_{binder} of water.

With approximately 40% p/p_{binder} of water, the pasty mixture is optimally set by pressing and with approximately 80% p/p_{binder} of water, and the more fluid pasty mixture is optimally formatted by casting.

According to the aggregates of alumina employed and the proportion of water used for the preparation of the pasty mixture, the mechanical resistance to compression varies from 5 to 40 Mpa for 28 days (according to standard NF EN 196.1) and the mechanical resistance to bending varies from 1 to 10 Mpa for 28 days (according to standard NF EN 196.1).

The applicant furthermore noticed that the refractory material made in accordance with the invention was having a low thermal dilation coefficient α=10⁻⁶ K⁻¹ that allows it to effectively resist repeated thermal shocks.

When the material made according to the invention is subjected to temperatures less than 1100° C., the refractory properties of the anhydrite III and the alumina suffice to resist the heat.

The porosity and the density of the material make it possible to vary the refractory and mechanical properties as explained previously.

At approximately 1100° C., a gradient of phases appears in the structure of the material, the rehydrated anhydrite III and the alumina reacting to form a calcium sulphate-aluminate exterior skin according to the reaction:

4(CaSO₄,2H₂O)+3(Al₂O₃)→(CaO)₄(Al₂O₃)₃SO₃+calcium aluminate (at ˜1100° C.)

One never obtains 100% of (CaO)₄(Al₂O₃)₃SO₃ due to the fact that the anhydrite III hydraulic binder and the alumina aggregates include impurities. The same applies if the compositions are not mixed in stoichiometric proportions.

Referring to FIG. 1, the calcium sulphate-aluminate will be formed only on a thin layer 1 on the order of several millimeters on the area of the surface 2 of the refractory material 4 in contact with the heat source 3, to create a heat shield.

This particular process enabling attainment of a calcium sulphate-aluminate refractory material is simpler and less expansive than the existing processes, the formation of calcium sulphate-aluminate being carried out at the time when the refractory material is in contact with heat and not before, no other energy than that emitted by the heat source being necessary.

The applicant surprisingly demonstrated that the calcium sulphate-aluminate formed in accordance with the invention acts as a powerful heat shield, the refractory material according to the invention absorbing only very little thermal energy emitted by the heat source.

The applicant calculated thermal exchanges on a refractory brick 5 (FIG. 2) made from a conventional sulphate-aluminous cement and on a refractory brick 4 (FIG. 1) made in accordance with the invention from a granular composition including 30% p/p_{composition} anhydrite III hydraulic binder made according to the process described in the patent application FR2804423 and 70% p/p_{composition} of calcinated bauxite, the aforementioned composition being mixed with 47% p/p_{binder} of water. The two bricks have substantially the same dimensions.

Referring to the attached figures, one of the faces of each tested brick is subjected to a flame (blowtorch) of approximately 1600° C. (emitted thermal energy E). With the aid of sensors arranged on the area of bricks 4 and 5, one determines the thermal energy reflected R, absorbed A, and transmitted T. The results are compiled in the following table 2.

TABLE 2
results

| | Energy | | |
|---|---|---|---|
| | Reflected | Absorbed | |
| | thermal | thermal | Transmitted |
| | energy | energy | thermal |
| | (% emitted | (% emitted | energy |
| | thermal | thermal | (% emitted |
| | energy) | energy) | energy) |
| Conventional | 20 | 40 | 40 |
| refractory brick | | | |
| Refractory brick | 70 | 20 | 10 |
| according to the | | | |
| invention | | | |

These results clearly show that the layer of sulphate-aluminate formed on the refractory brick in accordance with the invention acts as a powerful heat shield since 70 of emitted thermal energy is reflected.

The applicant also demonstrated that the reflecting capacity of the layer of calcium sulphate-aluminate was improved by using an anhydrite III hydraulic binder and anhydrite II, the maximum reflecting properties being when the proportion of anhydrite III is greater than that of anhydrite II.

Consequently, many industrial applications are possible. One can in particular use this refractory material according to the invention for passive protection of the wood, concrete, and steel structures (firebreaks of 2 to 6 hours), for manufacture of firebreak panels, such as active fillers for mortar and refractory concretes, for storage of nuclear wastes, recycling of refractory wasted, for interior cladding of metallurgical industrial furnaces, for manufacture of composite firebreak panels, for fire protection coatings, for thermal shield coatings, etc.

The average thermal conductivity of the refractory material in accordance with the invention is from 0.6 W/m.° K to 1054° C. according to standard ASTM C-417.

According to the same standard, the thermal conductivity is from 0.7 W/m.° K to 152° C. for a refractory material manufactured in accordance with the invention with 40% p/P_{binder} of water and from 0.45 W/m.° K to 182° C. for a refractory material manufactured in accordance with the invention with 80% p/p_{binder} of water.

1-21. (canceled)

22. Refractory material formed by the mixture of a granular composition including an anhydrite III hydraulic binder and an alumina aggregate, with water, characterized by the fact that the anhydrite III hydraulic binder and the alumina aggregate are doped to react 3 to 5 moles of anhydrite III with 2 to 4 moles of alumina and to form, starting from 1100° C., a calcium sulphate-aluminate exterior skin.

23. Refractory material according to claim 22, characterized by the fact that the anhydrite III hydraulic binder and the alumina aggregate are doped to react 4 moles of anhydrite III with 3 moles of alumina.

24. Refractory material according claim 22, characterized by the fact that the hydraulic binder is also based on anhydrite II.

25. Refractory material according to claim 24, characterized by the fact that the hydraulic binder includes a proportion of anhydrite III greater than the proportion of anhydrite II.

26. Refractory material according to according to claim 22, characterized by the fact that the alumina aggregate is selected from the list of the following aggregates taken alone or in combination: calcinated bauxite, tabular alumina, calcinated alumina, calcinated refractory clay, refractory chamotte, pearlite, vermiculite, bentonite, magnesite, dolomite, slag, white or brown corundums, kerphalite, alumina hydrate, recycled asbestos, molten aluminous cement.

27. Refractory material according to according to claim 22, characterized by the fact that the alumina aggregate includes spinel of alumina magnesia

28. Refractory material according to according to claim 22, characterized by the fact that the hydraulic binder is based on stabilized anhydrite III.

29. Manufacturing process of the refractory material according to according to claim 22, characterized by the fact that it comprises:
a) mixing the granular composition with water to from a pasty mixture,
b) implementing the pasty mixture according to the desired application,
c) leaving the pasty mixture to dry until it hardens to form the refractory material.

30. Process according to claim 29, characterized by the fact that the proportion of water mixed with the granular composition ranges between 40% and 80% p/p_{binder}.

31. Use of a granular composition including an anhydrite III hydraulic binder and an alumina aggregate doped to react 3 to 5 moles of anhydrite III with 2 to 4 moles of alumina, for the manufacture of a refractory material having, starting from 1100° C., a calcium sulphate-aluminate exterior skin.

32. Manufacturing process of a granular composition designed to react with water to form a refractory material having, starting from 1100° C., a calcium sulphate-aluminate exterior skin, the aforementioned process comprising dry mixing an anhydrite III hydraulic binder stabilized with an alumina aggregate, the stabilized anhydrite III hydraulic binder and the alumina aggregate being doped to react 3 to 5 moles of anhydrite III with 2 to 4 moles of alumina.

33. Process according to claim 32, characterized by the fact that it comprises:
a) heating the calcium sulphate to a dehydration temperature ranging between 220° C. and 360° C. according to the nature of the calcium sulphate treated to form anhydrite III,
b) mixing, at the dehydration temperature, the anhydrite III with the alumina aggregate.

34. Process according to claim 32, characterized by the fact that it comprises:
a) heating the calcium sulphate to a dehydration temperature ranging between 220° C. and 360° C. according to the nature of the calcium sulphate treated to form the anhydrite III,
b) mixing, in a dry atmosphere, the anhydrite III with the alumina aggregate.

35. Process according to claim 32, characterized by the fact that it comprises:
a) heating the calcium sulphate to a dehydration temperature greater than 360° C. according to the nature of the calcium sulphate treated to form anhydrite II and anhydrite III,
b) mixing the anhydrite II and the anhydrite III with the alumina aggregate.
